(19) United States
(12) Patent Application Publication
(10) Pub. No.: US 2014/0355298 A1
(43) Pub. Date: Dec. 4, 2014

(54) ADHESIVE LIGHTGUIDE WITH RESONANT CIRCUIT

(71) Applicant: 3M Innovative Properties Company, St. Paul, MN (US)

(72) Inventors: MICHAEL A. MEIS, STILLWATER, MN (US); AUDREY A. SHERMAN, SAINT PAUL, MN (US); ERIK A. AHO, NORTH SAINT PAUL, MN (US); ROBIN E. GORRELL, CEDAR PARK, TX (US); GEORGE D. KOKKOSOULIS, CEDAR PARK, TX (US); KEVIN R. SCHAFFER, WOODBURY, MN (US); DELONY L. LANGER-ANDERSON, SAINT PAUL, MN (US); ALAN G. HULME-LOWE, AUSTIN, TX (US)

(21) Appl. No.: 13/906,467

(22) Filed: May 31, 2013

(51) Int. Cl. F21V 8/00

(52) U.S. Cl. CPC G02B 6/0081
USPC 362/602

(57) ABSTRACT

Optical articles that include adhesive lightguides having resonant circuits and one or more light sources are described. More particularly, optical articles having resonant circuits that, upon a triggering event, cause the one or more light source to emit light into the adhesive lightguide such that light is transported within the lightguide by total internal reflection are described. Additionally, applications and embodiments that include such optical articles are described.

Remotely powered lightguides, such as those described in PCT Publication WO 2011/053804 A2 are useful in many applications. Because there is no need to store an internal power supply, devices including such lightguides can provide illumination over an extended lifetime, without being limited by a battery or the like. As many are controlled by the presence or absence of power, transmitted through electromagnetic waves, interesting and aesthetically pleasing dynamic displays may be created by simply controlling the electromagnetic waves.

### BACKGROUND

### Summary

In one aspect, the present disclosure describes an optical article including an adhesive lightguide including one or more light sources and a resonant circuit, where upon a triggering event, the resonant circuit causes the light source to emit light into the adhesive lightguide such that light is transported within the lightguide by total internal reflection until being extracted.

### BRIEF DESCRIPTION OF THE DRAWINGS

FIG. 1 is a sectional elevation view of the basic principles of an adhesive lightguide.

FIG. 2 is a schematic illustrating the currently disclosed resonant circuit.

FIG. 3 is a flowchart depicting the operation of the resonant circuit of FIG. 2.

FIG. 4 is a sectional elevation view of an adhesive lightguide and the resonant circuit of FIG. 2.

FIG. 5 is a sectional elevation view of an optical stack including the adhesive lightguide and the resonant circuit of FIG. 4.

FIG. 6 is a top perspective view of a credit card including the adhesive lightguide and resonant circuit of FIG. 4.

FIG. 7. is a top perspective view of a casino chip including the adhesive lightguide and resonant circuit of FIG. 4.

FIG. 8 is a top perspective view of a product label including the adhesive lightguide and resonant circuit of FIG. 4.

### DETAILED DESCRIPTION

Adhesive lightguides are desirable in many applications, particularly those where thinness, low weight, and flexibility may be advantageous. Adhesive lightguides are also useful because adhesive layers are already present in many configurations; in other words, they may be incorporated into existing designs to add illumination without considerable redesign or modification, even maintaining the overall appearance of the existing design.

Lightguides in general can provide smooth and uniform illumination, spreading light from one or more sources across a relatively large surface. Light is generally transported within the lightguide through total internal reflection (TIR), reflecting until extracted or escaping through a surface of the lightguide. To preserve TIR within the lightguide, the surfaces of a lightguide are often in optical contact with a lower refractive index material or coating, or simply with air (having, by definition, an index of refraction of 1.0).

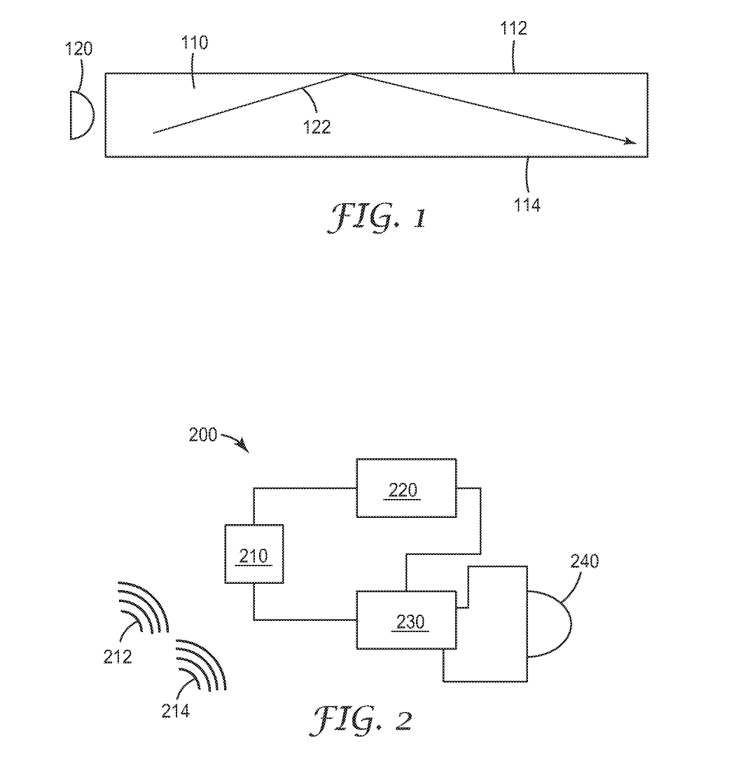

FIG. 1 is a sectional elevation view showing the general principles of an adhesive lightguide. Adhesive lightguide 110 forms top interface 112 and bottom interface 114 with surrounding air. One or more light sources 120 injects ray 122 into the lightguide.

Adhesive lightguide 110 may be generally formed from any suitable adhesive. The size or three-dimensional shape of adhesive lightguide 110 is not particularly limited and may be modified or selected depending on the desired application. The adhesive lightguide may include, for example, hot melt adhesives or curable adhesives. In some embodiments, adhesive lightguide 110 may include a viscoelastic material or be a viscoelastic lightguide.

Viscoelastic materials, in general, exhibit both elastic and viscous behavior when undergoing deformation. Exhibiting elastic characteristics refers to the ability of a material to return to its original shape after a transient load is removed. One measure of the elasticity of a material is referred to as the tensile set value, which is a function of the elongation remaining after the material has been stretched and subsequently allowed to recover (destretch) under the same conditions under which it was stretched. If a material has a tensile set value of 0%, then it has returned to its original length upon relaxation, whereas if the tensile set value is 100%, then the material is twice its original length upon relaxation. Tensile set values may be measured using ASTM D412. Useful viscoelastic materials may have tensile set values anywhere from 10% to 70%.

Viscous materials that are Newtonian liquids have viscous characteristics that obey Newton's law, which states that stress increases linearly with shear gradient. A liquid does not recover its shape as the shear gradient is removed. Viscous characteristics of useful viscoelastic materials include flowability of the material under reasonable temperatures such that the material does not decompose.

The viscoelastic lightguide may have properties that facilitate sufficient contact or wetting with at least a portion of a material designed to extract light from the lightguide, such that the viscoelastic lightguide and the material are optically coupled. Light can then be extracted from the viscoelastic lightguide. Viscoelastic lightguides are generally soft, compliant, and flexible. Thus, the lightguide may have an elastic modulus (or storage modulus G′) such that sufficient contact can be obtained, and a viscous modulus (or loss modulus G″) such that the layer does not flow undesirably, and a damping coefficient (G″/G′, tan D) for the relative degree of damping of the layer. Useful viscoelastic materials may have a storage modulus of less than about 300,000 Pa, measured at 10 rad/sec and a temperature of from about 20° to 22° C. Viscoelastic properties of materials can be measured using dynamic mechanical analysis according to, for example, ASTM D4065, D4440, and D5279.

In some embodiments, the viscoelastic lightguide includes a pressure sensitive adhesive (PSA) as described in the Dahlquist criterion line (as described in the Handbook of Pressure Sensitive Adhesive Technology, 2^{nd} Ed., D. Satas, ed., Van Nostrand Reinhold, New York, 1989). PSAs are useful for adhering together adherends and exhibit properties such as aggressive and permanent tack, adherence with no more than finger pressure, sufficient ability to hold onto an adherend, and sufficient cohesive strength to be cleanly removable from the adherend. Materials found to function well as PSAs are polymers designed and formulated to exhibit the requisite viscoelastic properties resulting in a desired balance of tack, peel adhesion, and shear holding power.

In some embodiments, the viscoelastic lightguide includes natural rubber-based or synthetic rubber-based PSAs, thermoplastic elastomers, tackified thermoplastic-epoxy derivatives such as, for example, is described in U.S. Pat. No. 7,005,394 (Ylitalo et al.), polyurethane derivatives as described in, for example, U.S. Pat. No. 3,718,712 (Tushaus), polyurethane acrylate derivatives as described in, for example, U.S. Patent Publication No. 2006-0216523 A1 (Takaki), silicone PSAs such as polydiorganosiloxanes, polydiorganosiloxane polyoxamides, and silicone urea block copolymers as described, for example, in U.S. Pat. No. 5,214,119 (Leir et al.). In some embodiments, the viscoelastic lightguide includes a clear acrylic PSA, for example, those available as transfer tapes such as VHB™ Acrylic Tape 4910F from 3M Company and 3M™ Optically Clear Laminating Adhesives (8140 and 8180 series). In some embodiments, the viscoelastic lightguide may be stretch releasable or repositionable.

Adhesive lightguide 110 may have any suitable index of refraction. In some embodiments, it may be advantageous to use an adhesive with a high index of refraction, because then a wider range of materials may be used as the lower index of refraction cladding layers, to reflect light being transported within adhesive lightguide 110 through TIR. Adhesive lightguide 110 may also have its materials selected as not to be electrically conductive to avoid shorting an embedded circuit or electronic components. Adhesive lightguide 110 may include extraction features either near top interface 112 or bottom interface 114. The extraction features may be any suitable shape or size, and may either divert light being transported within the adhesive lightguide to alternative paths where it may be extracted, or provide canted features which modify the incidence angle of light on either top interface 112 or bottom interface 114. In other words, extraction features may be any known structures which frustrate total internal reflection and cause light to be extracted through a surface of adhesive lightguide 110.

One or more light sources 120 may be any suitable configuration or combination of light sources, including light emitting diodes (LEDs) and organic light emitting diodes (OLEDs). Depending on the application, compact cold fluorescent lights or incandescent lights may also be used. One or more light sources 120 may include LEDs emitting in any desirable wavelength range, including a combination of wavelengths to create the appearance of white light. Some of one or more light sources 120 may include phosphors or other down converting coatings or layers in order to achieve a desired light spectrum. In some embodiments, one or more light sources 120 may include collimating (LEDs, for example, generally emit a Lambertian distribution of light) or light injection optics to minimize Fresnel reflection at any refractive index transition as light from one or more light sources 120 enters the lightguide. Generally, one or more light sources 120 is placed at an edge or side of adhesive lightguide 110, though in some embodiments it may be desirable to include one or more light sources 120 in adhesive lightguide 110 for ease of injection with little loss. Incorporating one or more light sources 120 in adhesive lightguide 110 may also facilitate easy application of an entire system, requiring only application of adhesive lightguide 110 to create an operative embodiment. Incorporating one or more light source 120 into adhesive lightguide 110 may include either embedding one or more light sources 120 directly in the adhesive or using a removed portion of the adhesive to house one or more light sources 120.

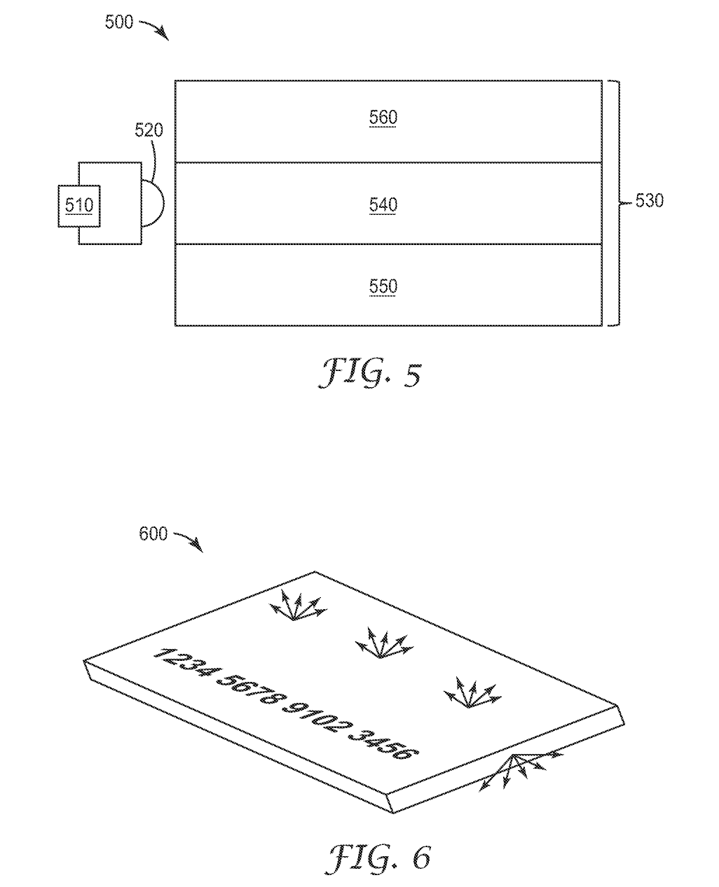

One or more light sources 120 emit ray 122 which enters adhesive lightguide 110 and is transported within the lightguide through total internal reflection—here, between top interface 112 and bottom interface 114. For purposes of this disclosure, transported through TIR means kept within the adhesive lightguide until it is extracted. Ray 122 is incident on top interface 112 as subcritical light; that is, the angle of incidence between ray 122 and the top surface of adhesive lightguide 110 is less than the critical angle determined by the difference in refractive indices between adhesive lightguide 110 and whatever material (including, for example, air) is on the other side of top interface 112, and is therefore reflected with minimal loss. Top interface 112 and bottom interface 114 can be formed between adhesive lightguide 110 and air, as shown, or they can be formed between adhesive lightguide 110 and other layers, described in more detail in conjunction with FIG. 5.

FIG. 2 is a schematic diagram illustrating an exemplary resonant circuit. Resonant circuit 200 includes receiver 210 which may be adapted specifically to electromagnetic wave 212 and data 214, capacitor 220, processor 230, and one or more light sources 240. The components illustrated should not be understood to be exhaustive, presented only to provide a general understanding of the operational mechanisms of resonant circuit 200 and it should be readily apparent to one skilled in the art the alternative configurations, including additional parts such as a transmitter, or combinations of parts into multifunctional components, is possible and within the scope of this disclosure.

Electromagnetic wave 212 and data 214 are similarly shown for ease of illustration and explanation as two separate waveforms; however, in some embodiments, data 214 may be superimposed or otherwise encoded in electromagnetic wave 212. For example, data 214 may exist in modulation of one or more aspects of electromagnetic wave 212, such as phase modulation, amplitude modulation, or frequency modulation. Electromagnetic wave 212 is contemplated as emitted from any suitable transmitter. Depending on the suitability of significant power usage, the transmitter may be a short or long distance transmitter, and may transmit at any suitable power. Electromagnetic wave 212 may have any suitable frequency or range of frequencies, and, likewise, receiver 210 may be adapted to introduce electromagnetic wave 212 into resonant circuit 200.

In some embodiments, receiver 210 may be an antenna, being of suitable size (coiled or uncoiled) with relation to the frequency of electromagnetic wave 212. The antenna may be formed of any suitable material, including materials with good electrical conductance, such as copper. In some embodiments, receiver 210 may be formed by printing conductive ink or by etching or patterning on a circuit board. Receiver 210 may, in some embodiments, be part of a chip—for example, an RFID chip or an NFC chip.

Capacitor 220 may be formed from any suitable material and may have any suitable capacitance. Capacitor 220 may be selected based on its small or compact size or ability to be easily integrated within an adhesive lightguide or a construction including an adhesive lightguide. In conjunction with receiver 210, capacitor 220 may be selected to allow resonant circuit 200 to resonate when exposed to a particular frequency of electromagnetic wave 212, causing current to flow in the circuit. The frequency at which this resonance would be greatest is determined from well-known calculations based on the capacitance of capacitor 220, the inductance of receiver 210, and the characteristics of the circuit, for example, taking into account any included resistors or simply inherent electrical impedance. In some embodiments, the inherent capacitance of an attached LED may function as a capacitor.

Processor 230 is generalized in FIG. 2 and may in fact be any suitable chip, electronic component, logic gate, or a combination thereof. In some embodiments, processor 230 may act as or contain a switch that allows current to flow into one or more light sources 240. Processor 230 may require power to operate and therefore may depend on current flow introduced into resonant circuit 200 by receiver 210 accepting electromagnetic wave 212. In other embodiments, processor 230 may contain an internal (or built-in) capacitor which may store charge while resonant circuit 200 is made to resonate, later selectively discharging the stored energy through one or more light sources 240. Processor 230 may include a transmitter, which may transmit data or other information, depending on the desired application. Processor 230 may be configured to provide two-way communication capacity. In some embodiments, in acting as a switch, processor 230 may measure, check, or verify any number of properties. For example, processor 230 may detect data 214 and respond by closing the switch to one of more light sources 240, allowing current to flow through the LED and causing it to emit light. In some embodiments, processor 230 may interpret or measure data 214; for example, processor 230 may close the switch to one of more light sources 240 after processor 230 detects data 214 for a certain period of time or after receiving a particular sequence or, in some embodiments, a passcode encoded in data 214. Though data 214 is depicted similarly to electromagnetic wave 212, the two are not necessarily both electromagnetic waves. In fact, data 214 may be information capable of being communicated or received by processor 230 through any suitable means. For example, data 214 may represent a level or current, a duration of the presence of current, or a physical interaction with the system, such as a touch or vibration, ambient conditions, such as temperature or orientation. The triggering event for closing the switch or releasing a charge in processor is not limited and may be suitably configured depending on the desired application. Further examples of triggering events and configurations are provided in conjunction with FIGS. 6, 7, and 8.

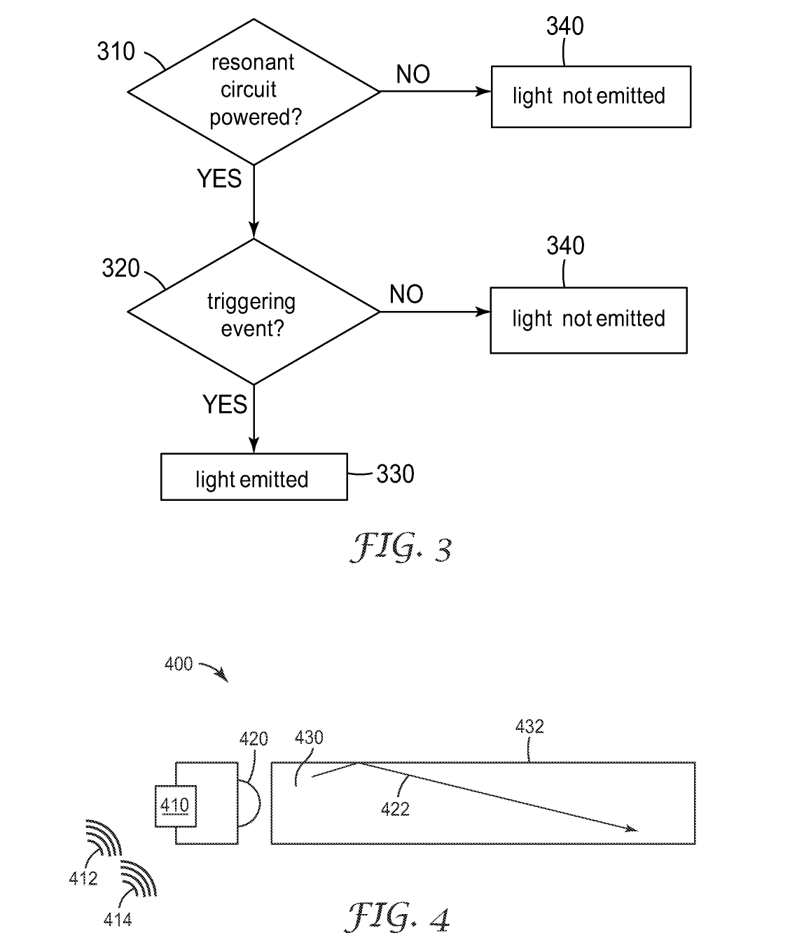

FIG. 3 is a flowchart illustrating the general operational algorithm of the resonant circuit illustrated in FIG. 2. Ultimately the algorithm results in emission of light, 330, or no emission of light, 340. First, resonant circuit, for example, resonant circuit 200 in FIG. 2, must be activated or powered, for example, by electromagnetic wave 212. If resonant circuit is not powered, the result is no emission of light, 340. Secondarily, the triggering event must occur. Without the triggering event, there is no emission of light, 340. Further, it is important that the triggering event is separate and distinct from the mere powering of the resonant circuit. If both these conditions are met, there is emission of light, 330. In some embodiments, this order of steps is less strict. For example, if processor 220 in FIG. 2 is adapted to receive and store charge when resonant circuit 200 is activated, then the triggering event may cause emission of light, 330, without the additional condition, 310, of the powering of the resonant circuit being met at the same time. Further, processor 230 as depicted in FIG. 2 may cause the one or more light sources to emit light in a pattern, like, for example, a strobe, flash, or blinker, where the one or more light sources is not emitting light for at least a portion of the pattern. In this case, satisfaction of both conditions 310 and 320 may still be considered to result in emission of light, 330, regardless of whether actual emission of light is happening at a given moment.

FIG. 4 is a sectional elevation view of system 400 including an adhesive lightguide and the resonant circuit of FIG. 2. Resonant circuit 410 is simplified in this figure and may be understood to include all of the electronic components depicted in resonant circuit 200 in FIG. 2. One or more light sources 420, however, is depicted separately. Upon receiving electromagnetic wave 412 and data 414, resonant circuit 410 causes one or more light sources 420 to emit light into adhesive lightguide 430. Light 422 is transported within adhesive lightguide 430 through TIR, being totally internally reflected at high-to-low index interfaces such as top interface 432. System 400 can be adapted for use to provide light after a triggering event, provided electromagnetic wave 412 is sufficient to power resonant circuit 410.

FIG. 5 is a sectional elevation view of an optical stack including the adhesive lightguide and resonant circuit of FIG. 4. System 500 includes resonant circuit 510, one or more light sources 520, and optical stack 530, which includes adhesive lightguide 540, optional bottom layers 550 and optional top layers 560. Resonant circuit 510 and one or more light sources 520 are described in FIGS. 1 and 2 and their corresponding descriptions. Similarly, adhesive light guide is described in FIGS. 1 and 4 and their corresponding descriptions. Optical stack 530 may include any number of layers, films, coatings or adhesives in order to create a desired optical effect or achieve a desired optical performance. The terms top and bottom with reference to optional layers 550 and 560 are based on their relative position in FIG. 5 for the ease of explanation, however, unless described features are explicitly restricted to one of the layers, the description of either is interchangeable with the other. Further, although each of optional bottom layers 550 and optional top layers 560 are depicted as a single monolithic layer, the skilled artisan will understand that each may represent one or more layers, films, coatings, or adhesive layers—even hundreds—limited only by the tolerable thickness and optical performance.

One or more of optional layers 550 and 560 may include substrate layers. Substrate layers may be any suitable thickness and be formed from any suitable material, such as polyethylene terephthalate (PET), polyethylene naphthalate (PEN), poly(methyl methacrylate) (PMMA), or polycarbonate (PC). Substrate layers may be used to provide dimensional stability, warp resistance, or provide optical separation between layers. In some embodiments, substrate layers may be optically inert, intended to minimally affect light passing through and instead providing thickness or durability. In some embodiments, substrates may be used to improve adherence of adjacent layers.

One or more of optional layers 550 and 560 may also be a prism film. Such films may help collimate output light in one or more directions through refraction and total internal reflection interactions between the light and the prism layers. Many prism films are commercially available and may be incorporated into optical stack 530, such as Brightness Enhancing Film (BEF), available from 3M Company, St. Paul, Minn. The prisms may have any suitable pitch and size, and may be any suitable shape, including triangular, rounded, triangular with anti-wetout tips, or even randomized or pseudo-randomized.

The optional layers may include a light redirecting film or turning film. Turning films may be useful for changing the angle of output light. For example, light incident normally on a turning film may be outputted by the film on average at, for example, 70° from the surface. The index of refraction may be selected in order to balance the optimal optical turning effect with Fresnel reflection.

The optional layers may also include skin layers, or in some embodiments strippable skin layers. Such layers may provide protection to components of optical stack 530 during transportation, manufacturing, storage or assembly. These layers may be removable (or strippable) for final application.

One or more of optional layers may be a multilayer optical film (MOF), including a reflective polarizer (such as DBEF, available from 3M Company, St. Paul, Minn.), a transflector, or a mirror film (such as ESR, available from 3M Company, St. Paul, Minn.). Such films may be advantageous by providing excellent optical performance combined with thin, lightweight constructions. A mirror film may be useful in optical stack 530 by allowing light headed in undesirable directions to be redirected with minimal absorptive loss. Mirror films may be useful in light recycling cavities, allowing light traveling in non-preferential directions to be reflected and redirected until it emerges in a preferred direction. The films may include extraction features such as printed dots to provide a desired specularity (or diffuseness) for the reflection pattern. In some embodiments, the optional layers may include a retroreflective film or retroreflective portions. These retroreflective films and retroreflective portions may be useful in creating a virtual image, or a three-dimensional effect where an image appears to float above the surface of optical stack 530.

Optional layers may include an optically clear adhesive, including UV curable adhesives, hot melt adhesives, pressure sensitive adhesives, or any other suitable adhesive. In some embodiments, the adhesive may include particles to diffuse light, resulting in increased uniformity or defect hiding. The adhesives may also include pigments to impart a color when illuminated or provide an interesting off-state for system 500.

In some embodiments, optical stack 530 may include one or more coatings. Coatings may provide desired features or optical function, for example, anti-static coatings, anti-wetout coatings, anti-reflective coatings, anti-glare coatings, or scratch resistant coatings. In some embodiments, the coatings may have a low refractive index to promote total internal reflection within adjacent layers. In some embodiments, the coatings may include fumed silica or a nanovoided polymeric material.

Optional layers may include a diffuser, including bulk or volume diffusers or structural diffusers. Diffusers may contribute to the uniformity of output light and hide defects, such as scratches or wetted out portions of adjacent layers where total internal reflection is frustrated or defeated.

Optical stack 530 may include a black out film that includes an optically opaque layer to limit the light passing through the film. The film may cover only a portion of optical stack 530, resulting in selective extraction of light in an interesting pattern or shape. Similarly, optical stack 530 may include a graphic film. The graphic film may be selectively embossed or pigmented to provide different colors or brightness in different regions. For example, when illuminated, graphic film may reveal a logo, pattern, or graphic that was otherwise invisible or difficult to detect by a viewer. In some embodiments, the graphic may have a different appearance with and without illumination. In some embodiments, instead of being translucent or transparent, the graphic film produces the appearance of an image by being selectively reflective.

The overall shape of optical stack 530 is not particularly limited and may have any suitable curved, polygonal, or three-dimensional areal shape (from, for example, a top plan view). In some embodiments, the areal shape of optical stack 530 may resemble a logo.

FIG. 6 is a top perspective view of a credit card including the adhesive lightguide and resonant circuit of FIG. 4. Credit card 600 includes these as part of a system corresponding to system 500 of FIG. 5 including an optical stack corresponding to optical stack 530 of FIG. 5. In some embodiments, the adhesive lightguide and resonant circuit may be easily incorporated into credit card 600 because the standard design already includes an adhesive. As depicted in, for example, FIG. 3, credit card 600 may be illuminated when the included resonant circuit receives electromagnetic waves and a triggering event occurs. The triggering event is not intended to be limited by this description, but some particularly appropriate triggering events for an embodiment functioning as a credit card may include confirmation of a transaction, confirmation that a transaction is secure, confirmation that a vendor's system is secure, confirmation that communication has been established, indication of low balance, indication of an expired or near-expired card, or indication that a card has been reported stolen. For the purposes of this description, the term credit card is not limited to traditional credit cards but may be considered to include debit cards, prepaid cards, phone cards, casino player cards, ID cards, access cards, or any other card where the card contains information linked to the bearer or giving the bearer certain rights or privileges. For example, a casino card for a frequent player may illuminate when nearby certain types of games that the player enjoys, or it may glow brightly when the player is on a winning streak, creating a visually appealing feature that may entice the player to play more games. Any portion of credit card 600 may emit light, including the edge, or a pattern on the front or back surface, or a combination of the above.

FIG. 7 is a perspective view of a casino chip or token. Similar to the credit card depicted in FIG. 6, chip 700 includes the resonant circuit and adhesive lightguide of FIG. 4 as part of an optical stack corresponding to optical stack 530 of FIG. 5. As for credit card 600 in FIG. 6, chip 700 may selectively be illuminated upon its resonant circuit receiving appropriate electromagnetic waves and following a triggering event. Exemplary triggering events include winning a hand, confirming or entering a bet, or a change in capacitance (touch). These features may provide an exciting visual component while being hard to replicate or counterfeit. Illumination can be around an edge, out a major surface, or both, including illumination in a pattern, shape, or logo. The casino chip may be in any shape, including a substantially rectangular plaque which may denote higher denominations. In some embodiments, “casino chip” can refer to any token or other physical representation of a specific value or denomination, regardless of whether the chip is used or adapted to be used in a traditional casino or to specifically represent currency.

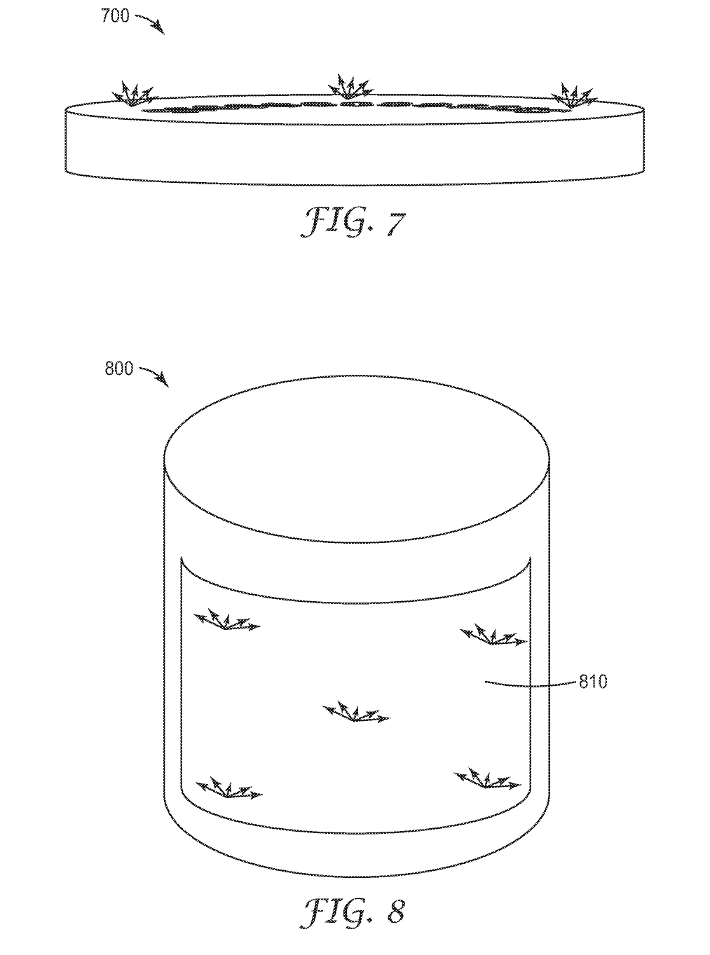

FIG. 8 is a perspective view of a product having a label including the adhesive lightguide and resonant circuit of FIG. 4. Product 800 includes label 810. The adhesive lightguide and resonant circuit may be easily incorporated in label 810, which is conventionally attached to product 800 with an adhesive. Therefore many of the manufacturing and processing steps for assembling and packaging product 810 may remain substantially the same. Product 800 may be, for example, a food product, such as a soup can. In some embodiments, product 800 may be displayed on a smart shelf, or a shelf that provides electromagnetic waves which can be received by the resonant circuit. Following a triggering event, one or more of product 800 may illuminate from its label 810 to draw attention or indicate information. For example, a shopper may input, through, for example, a smartphone or interface located on the shelf, a desire to locate products with certain nutritional characteristics, such as having less than 100 calories per serving or being low-fat. This query may be transmitted to the resonant circuit included in the products and may be a triggering event. As such, only products meeting the criteria may glow, allowing a shopper to easily identify desired products. In addition to illumination, product 800 may provide product information through the transmission of data. In some embodiments, product 800 may be, for example, an ink cartridge. In this case, the triggering event may be, for example, being low on ink or being installed in a printer having the same brand as the ink cartridge's brand. In addition to illumination, product 800 in this case may also provide compatibility information, product information, or other information through the transmission of data.

All U.S. patents and patent publications are incorporated by reference as if fully set forth herein. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims.

What is claimed is:

1. An optical article, comprising:
an adhesive lightguide including one or more light sources and a resonant circuit;
wherein upon a triggering event, the resonant circuit causes the light source to emit light into the adhesive lightguide such that the light is transported within the lightguide by total internal reflection until being extracted.

2. The optical article of claim 1, wherein the resonant circuit is capable of being powered by a series of electromagnetic waves.

3. The optical article of claim 2, wherein the series of electromagnetic waves contain encoded data.

4. The optical article of claim 3, wherein the encoded data includes frequency modulation data.

5. The optical article of claim 3, wherein the encoded data includes amplitude modulation data.

6. The optical article of claim 3, wherein the encoded data includes phase modulation data.

7. The optical article of claim 2, wherein the series of electromagnetic waves are radio waves.

8. The optical article of claim 1, wherein the resonant circuit includes a NFC receiver.

9. The optical article of claim 1, wherein the resonant circuit includes an RFID receiver.

10. The optical article of claim 1, wherein the resonant circuit includes a transmitter.

11. The optical article of claim 1, wherein the resonant circuit includes a processor.

12. The optical article of claim 1, wherein the triggering event is reaching a threshold current in the resonant circuit.

13. The optical article of claim 1, wherein the triggering event is the resonant circuit confirming that a transaction is valid.

14. The optical article of claim 1, wherein the triggering event is the resonant circuit confirming that a transaction is invalid.

15. The optical article of claim 13 or 14, wherein the transaction is a secure transaction.

16. The optical article of claim 1, wherein the adhesive lightguide includes a plurality of extraction features.

17. The optical article of claim 1, further comprising a first substrate disposed on a first major surface of the adhesive lightguide.

18. The optical article of claim 16, further comprising a second substrate disposed on a second major surface of the adhesive lightguide.

19. The optical article of claim 17, wherein one or both of the first substrate and the second substrate is a cladding layer.

20. The optical article of claim 16, wherein the first substrate includes a graphic.

21. A casino chip, comprising the optical article of claim 1.

22. A casino plaque, comprising the optical article of claim 1.

23. A credit card, comprising the optical article of claim 1.

24. A label, comprising the optical article of claim 1.

25. A product, comprising the label of claim 24.

26. An ink cartridge, comprising the label of claim 24.
